(19) United States
(12) Patent Application Publication
(10) Pub. No.: US 2026/0065400 A1
(43) Pub. Date: Mar. 5, 2026

(54) SYSTEM AND METHOD FOR CLASSROOM DATA MANAGEMENT

(71) Applicant: TAG Global, Amman (JO)

(72) Inventor: Talal Tawfiq Salem ABU-GHAZALEH, Amman (JO)

(73) Assignee: TAG Global, Amman (JO)

(21) Appl. No.: 19/310,046

(22) Filed: Aug. 26, 2025

Related U.S. Application Data
(60) Provisional application No. 63/687,468, filed on Aug. 27, 2024.

(51) Int. Cl. G06Q 50/20; G09B 5/02

(52) U.S. Cl. CPC G06Q 50/205; G09B 5/02

(57) ABSTRACT

Provided are system, method, and device for automatically perform classroom data management. According to example embodiments, the system may be configured to: receive, from a first user on a target device, a configuration input to configure data associated with a school class assigned to a second user; store, on the target device, the configured data; and display, to the second user on the target device, the configured data associated with the school class assigned to the second user; wherein the configured data associated with the school class assigned to the second user may include: one or more school classes assigned to the second user, a name associated with each of the one or more school classes assigned to the second user, and a study material associated with each of the one or more of school classes.

### TECHNICAL FIELD

Example embodiments of the present disclosure relate to data management, and more specifically, relate to the management of data associated with school classroom.

### BACKGROUND

Modern schools and educational institutions have become increasingly complex in recent history. In particular, the number of classes and subjects as well as the amount of content and complexity of the subject matter taught in said classes have been steadily rising.

At the same time, the use of electronic devices and software applications in classroom environment that facilitate the learning experience of students have also been rising in recent history.

### SUMMARY

Example embodiments consistent with the present disclosure enable efficient and effective management of data associated with the classroom in light of the increase in complexity, as well as to facilitate the learning process through such managed data.

According to example embodiments, a system is provided. The system may include: a memory storage storing computer-executable instructions; and at least one processor communicatively coupled to the memory storage, wherein the at least one processor may be configured to execute the instructions to: receive, from a first user on a target device, a configuration input to configure data associated with a school class assigned to a second user; store, on the target device, the configured data; and display, to the second user on the target device, the configured data associated with the school class assigned to the second user; wherein the configured data associated with the school class assigned to the second user may include: one or more school classes assigned to the second user, a name associated with each of the one or more school classes assigned to the second user, and a study material associated with each of the one or more of school classes.

According to example embodiments, the at least one processor may be configured to receive the configuration input from the first user by: receiving, from the first user on the target device, an identification information associated with the first user; displaying, to the first user on the target device, one or more school classes which the first user is responsible for based on the identification information associated with the first user; receiving, from the first user on the target device, a first selection input to select at least one of the one or more school classes; displaying, to the first user on the target device, one or more study materials associated with the selected at least one of the one or more school classes; receiving, from the first user on the target device, a second selection input to select at least one of the one of the one or more study materials; and obtaining, from a server, the selected at least one of the one of the one or more study materials.

According to example embodiments, the at least one processor may be further configured to receive, from the second user on the target device, a personalization input to personalize the configured data associated with the school class assigned to the second user.

According to example embodiments, the personalization input may include at least one of: an input to configure a personal note associated with a study material associated with one or more school classes assigned to the second user, an input to highlight a portion of the study material, and an input to bookmark a portion of the study material.

According to example embodiments, the at least one processor may be configured to display the configured information associated with the school class assigned to the second user by: displaying, to the second user on the target device, the one or more school classes assigned to the second user, and the name associated with each of the one or more school classes assigned to the second user; receiving, from the second user on the target device, a third selection input to select at least one of the one or more school classes assigned to the second user; displaying, to the second user on the target device, one or more study materials associated with the selected at least one of the one or more school classes assigned to the second user; receiving, from the second user on the target device, a fourth selection input to select at least one of the one of the one or more study materials; and displaying, to the second user on the target device, a content of the selected at least one of the one of the one or more study materials.

According to example embodiments, the content may be displayed along with one or more of: a personal note associated with the study material, a highlight of a portion of the study material; and a bookmark of a portion of the study material.

According to example embodiments, the system may include an administration user interface and a student user interface, wherein the configuration input may be received from the first user via the administration user interface, and wherein the configured data associated with the school class assigned to the second user may be displayed to the second user via the student user interface.

According to example embodiments, a method is provided. The method may include: receiving, from a first user on a target device, a configuration input to configure data associated with a school class assigned to a second user; storing, on the target device, the configured data; and displaying, to the second user on the target device, the configured data associated with the school class assigned to the second user; wherein the configured data associated with the school class assigned to the second user may include: one or more school classes assigned to the second user, a name associated with each of the one or more school classes assigned to the second user, and a study material associated with each of the one or more of school classes.

According to example embodiments, the receiving the configuration input from the first user may include: receiving, from the first user on the target device, an identification information associated with the first user; displaying, to the first user on the target device, one or more school classes which the first user is responsible for based on the identification information associated with the first user; receiving, from the first user on the target device, a first selection input to select at least one of the one or more school classes; displaying, to the first user on the target device, one or more study materials associated with the selected at least one of the one or more school classes; receiving, from the first user on the target device, a second selection input to select at least one of the one of the one or more study materials; and obtaining, from a server, the selected at least one of the one of the one or more study materials.

According to example embodiments, the method may further include receiving, from the second user on the target device, a personalization input to personalize the configured data associated with the school class assigned to the second user.

According to example embodiments, the personalization input may include at least one of: an input to configure a personal note associated with a study material associated with one or more school classes assigned to the second user, an input to highlight a portion of the study material, and an input to bookmark a portion of the study material.

According to example embodiments, the displaying the configured information associated with the school class assigned to the second user may include: displaying, to the second user on the target device, the one or more school classes assigned to the second user, and the name associated with each of the one or more school classes assigned to the second user; receiving, from the second user on the target device, a third selection input to select at least one of the one or more school classes assigned to the second user; displaying, to the second user on the target device, one or more study materials associated with the selected at least one of the one or more school classes assigned to the second user; receiving, from the second user on the target device, a fourth selection input to select at least one of the one of the one or more study materials; and displaying, to the second user on the target device, a content of the selected at least one of the one of the one or more study materials.

According to example embodiments, the content may be displayed along with one or more of: a personal note associated with the study material, a highlight of a portion of the study material; and a bookmark of a portion of the study material.

According to example embodiments, the method may be performed by a system that may include an administration user interface and a student user interface, wherein the configuration input may be received from the first user via the administration user interface, and wherein the configured data associated with the school class assigned to the second user may be displayed to the second user via the student user interface.

According to example embodiments, a non-transitory computer-readable recording medium is provided. The non-transitory computer-readable recording medium may have recorded thereon instructions executable by at least one processor to cause the at least one processor to perform a method including: receiving, from a first user on a target device, a configuration input to configure data associated with a school class assigned to a second user; storing, on the target device, the configured data; and displaying, to the second user on the target device, the configured data associated with the school class assigned to the second user; wherein the configured data associated with the school class assigned to the second user may include: one or more school classes assigned to the second user, a name associated with each of the one or more school classes assigned to the second user, and a study material associated with each of the one or more of school classes.

According to example embodiments, the receiving the configuration input from the first user may include: receiving, from the first user on the target device, an identification information associated with the first user; displaying, to the first user on the target device, one or more school classes which the first user is responsible for based on the identification information associated with the first user; receiving, from the first user on the target device, a first selection input to select at least one of the one or more school classes; displaying, to the first user on the target device, one or more study materials associated with the selected at least one of the one or more school classes; receiving, from the first user on the target device, a second selection input to select at least one of the one of the one or more study materials; and obtaining, from a server, the selected at least one of the one of the one or more study materials.

According to example embodiments, the method may further include receiving, from the second user on the target device, a personalization input to personalize the configured data associated with the school class assigned to the second user.

According to example embodiments, the personalization input may include at least one of: an input to configure a personal note associated with a study material associated with one or more school classes assigned to the second user, an input to highlight a portion of the study material, and an input to bookmark a portion of the study material.

According to example embodiments, the displaying the configured information associated with the school class assigned to the second user may include: displaying, to the second user on the target device, the one or more school classes assigned to the second user, and the name associated with each of the one or more school classes assigned to the second user; receiving, from the second user on the target device, a third selection input to select at least one of the one or more school classes assigned to the second user; displaying, to the second user on the target device, one or more study materials associated with the selected at least one of the one or more school classes assigned to the second user; receiving, from the second user on the target device, a fourth selection input to select at least one of the one of the one or more study materials; and displaying, to the second user on the target device, a content of the selected at least one of the one of the one or more study materials.

According to example embodiments, the content may be displayed along with one or more of: a personal note associated with the study material, a highlight of a portion of the study material; and a bookmark of a portion of the study material.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates a block diagram of an example system configuration for performing classroom data management, according to one or more example embodiments;

FIG. 2 illustrates a flow diagram of an example method for performing classroom data management, according to one or more example embodiments;

FIG. 3 illustrates a flow diagram of an example method for performing classroom data management, according to one or more example embodiments;

FIG. 4 illustrates a flow diagram of an example method for receiving a configuration input from a first user, according to one or more example embodiments;

FIG. 5A illustrates an example interface of an administration user interface configured to receive an identification information, according to one or more example embodiments;

FIG. 5B illustrates an example interface of an administration user interface configured to display one or more school classes which a first user is responsible for, according to one or more example embodiments;

FIG. 5C illustrates an example interface of an administration user interface configured to display one or more study materials associated with a selected at least one of one or more school classes, according to one or more example embodiments;

FIG. 6 illustrates a flow diagram of an example method 600 for displaying configured data associated with a school class assigned to a second user, according to one or more example embodiments;

FIG. 7A illustrates an example interface of a student user interface configured to display one or more school classes assigned to a second user, according to one or more example embodiments;

FIG. 7B illustrates an example interface of a student user interface configured to display one or more study materials associated with a selected at least one of one or more school classes assigned to the second user, according to one or more example embodiments;

FIG. 7C illustrates an example interface of a student user interface configured to display a content of a selected at least one of one of the one or more study materials, according to one or more example embodiments;

FIG. 7D illustrates an example interface of a student user interface configured to display a content of a personal note associated with a study material, according to one or more example embodiments;

FIG. 7E illustrates an example interface of a student user interface configured to receive a personalization input, according to one or more example embodiments; and

FIG. 8 illustrates a block diagram of example components in a system, according to one or more example embodiments.

### DETAILED DESCRIPTION

The following detailed description of exemplary embodiments refers to the accompanying drawings. The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “[A] and/or [B]”, “at least one of [A] and [B]” or “at least one of [A] or [B]” are to be understood as including only A, only B, or both A and B.

Expressions such as “at least one processor,” where configured to implement a plurality of operations, execute a plurality of instructions, etc., are to be understood as a single processor implementing the plurality of operations, etc., or each of plural processors implementing at least some (but not necessarily all) of the plurality of operations, etc.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Further, the described features, advantages, and characteristics of the present disclosure may be combined in any suitable manner in one or more example embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

As described above, the number of classes and subjects as well as the amount of content and complexity of the subject matter taught in said classes have been steadily rising in recent history. This also give rise to the amount and complexity of study materials associated with said subject matter which a student needs to process and understand.

At the same time, the use of electronic devices and software applications in classroom environment that facilitate the learning experience of students have also been rising in recent history

Accordingly, there is a need for a system that utilizes electronic devices and software applications in classroom environment to enable efficient and effective management of data associated with the classroom in light of the increase in complexity, as well as to facilitate the learning process through such managed data.

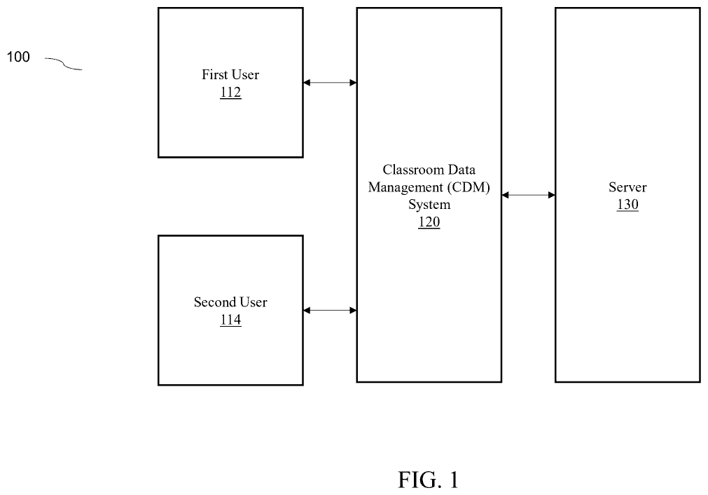

FIG. 1 illustrates a block diagram of an example system configuration 100 for performing classroom data management, according to one or more example embodiments. As illustrated in FIG. 1, system configuration 100 may include a first user 112, a second user 114, a classroom data management (CDM) system 120, and a server 130.

The first user 112 may include a school administrator. The school administrator may include, for example, a teacher, a professor, a faculty member, and the like which is responsible for teaching and giving lessons to students in an educational institution (school) through a plurality of school classes.

The second user 114 may include a school student which is receiving the lessons from the first user in the educational institution through one or more of the plurality of school classes.

In particular, for example, the fist user 112 may be a teacher in a school that is response for teaching a plurality of school classes (e.g., a math teacher responsible for geometry class, algebra class, calculus class, etc.), while the second user 114 may be a student in the school that is attending one or more of the plurality of school classes which the first user 112 is responsible for (e.g., a senior student attending the calculus class which the fist user 112 is teaching).

The CDM system 120 may include an apparatus, a system, a platform, a module, or the like, which may be configured to perform one or more operations or actions for performing classroom data management.

According to example embodiments, the CDM system 120 may include a software, an application, a program, and the like that may be implemented on a device (target device). The target device may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), a SIM-based device, or a similar device.

In this regard, according to example embodiments, the CDM system 120 may be configured to receive inputs from the first user 112 and the second user 114 via the target device. For example, the target device may include a smart phone with a touch screen, and the CDM system 120 may be configured to receive touch inputs from the first user 112 and the second user 114 via the touch screen of the smart phone.

Further, according to example embodiments, the CDM system 120 may be configured to provide outputs to the first user 112 and the second user 114 via the target device. For example, the target device may include a smart phone with a display screen, and the CDM system 120 may be configured to display data and information to the first user 112 and the second user 114 via the display screen of the smart phone.

Furthermore, according to example embodiments, the CDM system 120 may be communicatively coupled to the server 130 via one or more interfaces. For example, the target device may include a smart phone with a WIFI connection module, and the CDM system 120 may be configured to communicate with the server 130 to exchange data and information via the WIFI connection module of the smart phone.

According to example embodiments, the CDM system 120 (and/or the target device) may include a local database. The local database may be configured to store various configuration data and personalization data associated with a particular school student. In this regard, according to example embodiments, the target device may be specifically assigned and provided to the particular school student in the school.

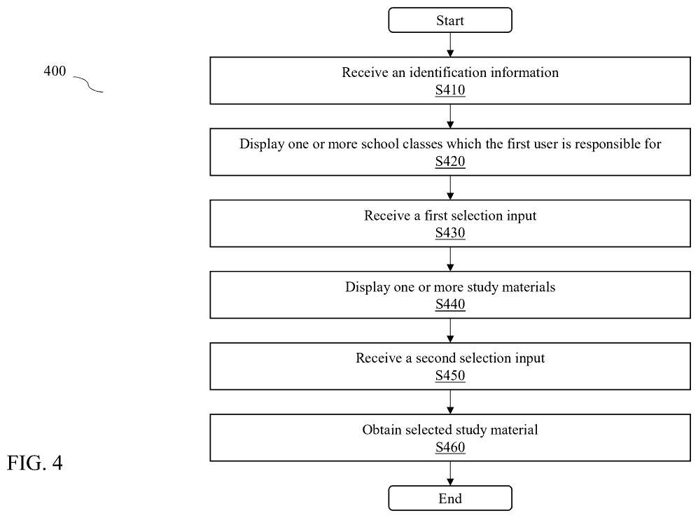

According to example embodiments, the CDM system 120 (and/or the target device) may include an administration user interface and a student user interface. In this regard, CDM system 120 (and/or the target device) may interact (receive input and provide output) with the first user 112 via the administration user interface, with the second user 114 via the student user interface. Additional descriptions associated with the administration user interface and the student user interface are provided below in relation to FIG. 4 to FIG. 7.

In other words, according to example embodiments, the CDM system 120 may include two primary modes associated with the administration user interface and the student user interface. The first mode may be referred to as the administration mode, where the first user 112 (school administrator) may enter the application, goes to the login screen, identifies the server link from which to obtain study materials for a specific school, and enters the username and password. Subsequently, the first user 112 may specify the school classes for various students and download the study materials for them on their assigned target devices. The first mode may be referred to as a user/student mode, where the CDM system 120 may display the second user 114 (school student) school classes that were assigned to him/her by the first user 112. Subsequently, the second user 114 may select the school classes, be shown various study materials, and begin studying the materials that the first user 112 had previously downloaded for the second user 114 as mentioned above.

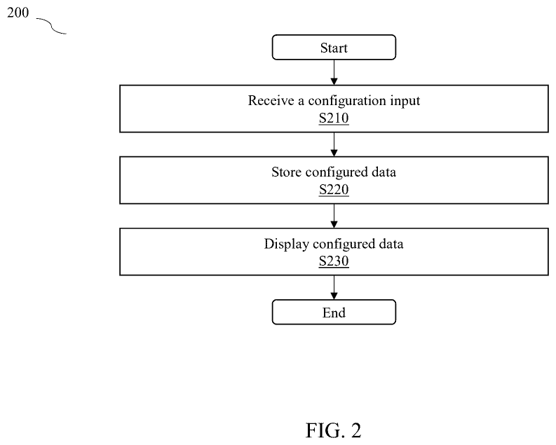

Example operations performable by the CDM system 120 for performing classroom data management are described below with reference to FIG. 2 to FIG. 7.

The server 130 may include a local server, a cloud server, a hybrid cloud server, a server cluster, and the like. According to example embodiments, the server 130 may act as a central database that stores various information associated with classroom data management.

In particular, according to example embodiments, the server 130 may store identification information associated with a plurality of school administrator in the educational institution, and may act to facilitate verification of the identity of the first user 112 that is utilizing with the CDM system 120. For example, the server 130 may store log in information (e.g., username and password) associated with each of the plurality of school administrator in the school, where the server 130 may facilitate verification of the identity of the first user 112 that is utilizing the CDM system 120 by receiving the log in information provided by the first user 112 from the CDM system 120.

Further, according to example embodiments, the server 130 may record a plurality of school classes that are taught in the educational institution, and may specify which of the plurality of school administrator is responsible for which of the plurality of school classes. For example, the server 130 may record geometry class, algebra class, information technology (IT) class, calculus class, art class, chemistry class, biology class, and physics class that are taught in the school, and may specify that Mr. Smith is responsible for geometry class, algebra class, IT class, and calculus class, Mr. Phil is responsible for art class, and Ms. White is responsible for chemistry class, biology class, and physics class.

Furthermore, according to example embodiments, the server 130 may store one or more study materials that are associated with each of the plurality of school classes that are taught in the educational institution. The study materials here may include, for example, books, articles, presentation slides, home works, tests, and any similar materials that may be used by a school administrator to facilitate teaching and giving lessons to students. For example, the server 130 may store an IT book that is associated with and used in the IT class.

In other words, according to example embodiments, the server 130 may include a web system configured to receive uploaded study materials, identify particular school administrator, and create username/password for various school administrators.

FIG. 2 illustrates a flow diagram of an example method 200 for performing classroom data management, according to one or more example embodiments. One or more operations in method 200 may be performed by at least one processor (e.g., processor 812) of the CDM system.

According to example embodiments, the CDM system may be implemented in the target device, where the target device may be assigned to a particular school student.

As illustrated in FIG. 2, at operation S210, the at least one processor may be configured to receive a configuration input. The configuration input may be received from a first user, and may include an input to configure data associated with a school class assigned to a second user.

The first user may include a school administrator, which may include, for example, a teacher, a professor, a faculty member, and the like which is responsible for teaching and giving lessons to students in an educational institution (school) through a plurality of school classes.

The second user may include a school student which is receiving the lessons from the first user in the educational institution through one or more of the plurality of school classes. In this regard, according to example embodiments, the second user may correspond to the particular school student which the target device is assigned to.

According to example embodiments, the configuration input may include an input to specify and assign at least one school class to the second user, as well as an input to provide at least one study material associated with the assigned at least one school class to the second user.

In this regard, according to example embodiments, the configured data associated with the school class assigned to the second user may include: one or more school classes assigned to the second user, a name associated with each of the one or more school classes assigned to the second user, and a study material associated with each of the one or more of school classes.

It is noted that the configured data associated with the school class assigned to the second user may include any additional information associated with the second user and/or the school class assigned to the second user. For example, the configured data associated with the school class assigned to the second user may include language settings associated with the second user, the name of the school which the second user is attending, and the like.

For example, the configuration input may include an input to specify and assign an information technology (IT) class to the second user, as well as an input to provide an IT book (e.g., PDF format) associated with the IT class to the second user. Accordingly, the data associated with the school class assigned to the second user may indicate that the second user is assigned to the IT class, and has the IT book.

According to example embodiments, the configuration input may be received on the target device. For example, the configuration input may be received via a touch screen of a smart phone (target device). According to example embodiments, the system (and/or the target device) may include an administration user interface, where the configuration input may be received from the first user via the administration user interface.

According to example embodiments, the at least one processor may be configured to receive the configuration input from the first user by: receiving, from the first user on the target device, an identification information associated with the first user; displaying, to the first user on the target device, one or more school classes which the first user is responsible for based on the identification information associated with the first user; receiving, from the first user on the target device, a first selection input to select at least one of the one or more school classes; displaying, to the first user on the target device, one or more study materials associated with the selected at least one of the one or more school classes; receiving, from the first user on the target device, a second selection input to select at least one of the one of the one or more study materials; and obtaining, from a server, the selected at least one of the one of the one or more study materials.

Examples of operations for receiving the configuration input are described below with reference to FIG. 4. The method then proceeds to operation S220.

At operation S220, the at least one processor may be configured to store the configured data. The configured data may be stored in a local database at the system (target device/CDM system).

For example, the target device/CDM system may store in its local database a record specifying that the second user is assigned to the IT class, and has the IT book.

In this regard, the local database may also store the study material itself. For example, the target device/CDM system may download and store the IT book. The method then proceeds to operation S230.

At operation S230, the at least one processor may be configured to display the configured data associated with the school class assigned to the second user.

For example, the CDM system may display a list of school classes that are assigned to the second user, along with a list of study materials associated with said school classes. Further, the CDM system may also display the study materials themselves, where the second user may read the IT book through the CDM system.

According to example embodiments, the configured data associated with the school class assigned to the second user may be displayed to the second user on the target device. For example, the configured data associated with the school class assigned to the second user may be displayed via a display screen of a smart phone (target device) to the second user. According to example embodiments, the system (and/or the target device) may include a student user interface, where the configured data associated with the school class assigned to the second user may be displayed to the second user via the student user interface.

According to example embodiments, the at least one processor may be configured to display the configured information associated with the school class assigned to the second user by: displaying, to the second user on the target device, the one or more school classes assigned to the second user, and the name associated with each of the one or more school classes assigned to the second user; receiving, from the second user on the target device, a third selection input to select at least one of the one or more school classes assigned to the second user; displaying, to the second user on the target device, one or more study materials associated with the selected at least one of the one or more school classes assigned to the second user; receiving, from the second user on the target device, a fourth selection input to select at least one of the one of the one or more study materials; and displaying, to the second user on the target device, a content of the selected at least one of the one of the one or more study materials.

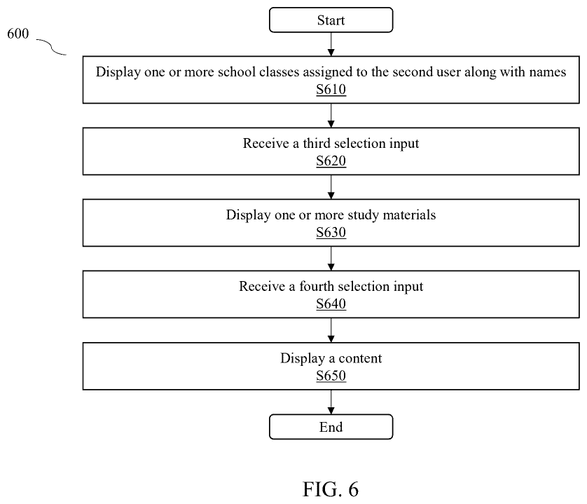

Examples of operations for displaying the configured data associated with the school class assigned to the second user are described below with reference to FIG. 6.

Upon performing operation S230, the method 200 may be ended or be terminated. Alternatively, method 200 may return to operation S210, such that the at least one processor may be configured to repeatedly perform, for at least a predetermined amount of time, the receiving the configuration input (at operation S210), the storing the configured data (at operation S220), and the displaying the configured data (at operation S230).

For example, the target device may initially be assigned and provided to the second user, where the first user may provide the configuration input to configure the data associated with the school class assigned to the second user. Accordingly, operations S210 to S230 may be performed as described above. Then at a later time, the second user may wish to see the assigned school classes and/or the study materials assigned to him/her. Accordingly, the method may return to operation S230 to display the configured data to the second user.

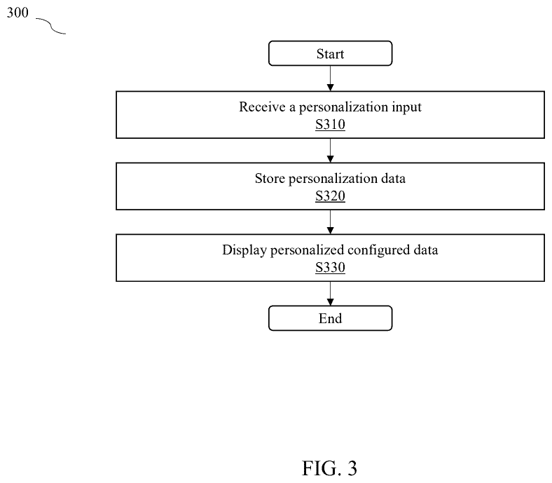

FIG. 3 illustrates a flow diagram of an example method 300 for performing classroom data management, according to one or more example embodiments. One or more operations in method 300 may be performed by at least one processor (e.g., processor 812) of the CDM system.

According to example embodiments, the CDM system may be implemented in the target device, where the target device may be assigned to a particular school student.

According to example embodiments, one or more operations in method 300 may be modified and/or combined with one or more operations in method 200 without limitation. For example, operations S310 to S330 in method 300 may be performed after operation S230 in method 200.

As illustrated in FIG. 3, at operation S310, the at least one processor may be configured to receive a personalization input.

The personalization input may be received from the second user, and may include an input to personalize the configured data associated with the school class assigned to the second user (i.e., obtained through the configuration input during operation S210 in method 200). In other words, the personalization input may include an input to provide/add personalization data to the configured data associated with the school class assigned to the second user.

According to example embodiments, the personalization input may include at least one of: an input to configure (add, modify, delete, etc.) a personal note associated with a study material associated with one or more school classes assigned to the second user, an input to highlight (highlight, underline, change text color, bold, etc.) a portion of the study material; and an input to bookmark a portion of the study material.

In this regard, according to example embodiments, the personalization data may include at least one of: the personal note, the highlight, and the bookmark.

For example, as described above in relation to operation S210 in method 200, the CDM system may display the IT book (i.e., study material associated with the IT class assigned to the second user) to the second user, such that the second user may read the IT book through the CDM system. In this regard, the user may wish to add a personal note to the IT book in order to add additional descriptions. Further, the user may wish to highlight specific sentences or paragraphs of the IT book to emphasize its importance. Furthermore, the user may wish to add a book mark to particular pages of the IT book to return to at a later time.

According to example embodiments, the personalization input may be received on the target device. For example, the personalization input may be received via a touch screen of a smart phone (target device). According to example embodiments, the personalization input may be received from the second user via the student user interface.

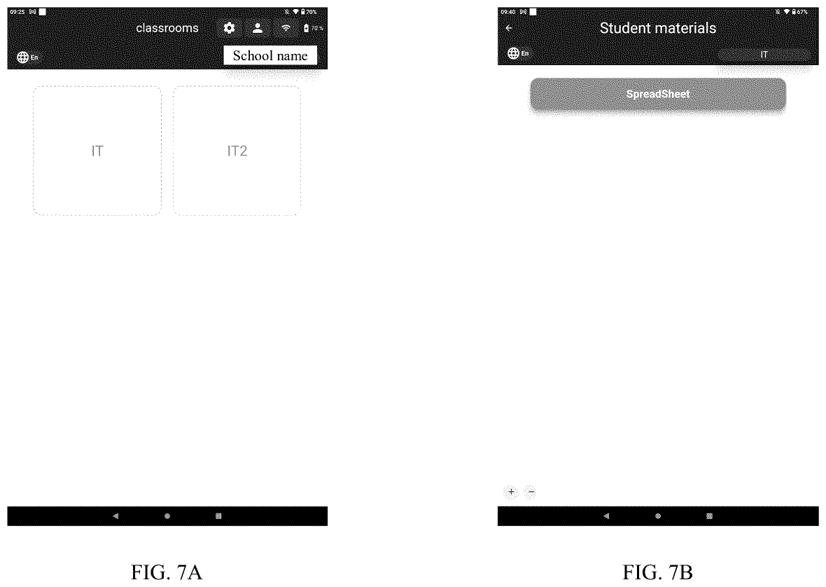

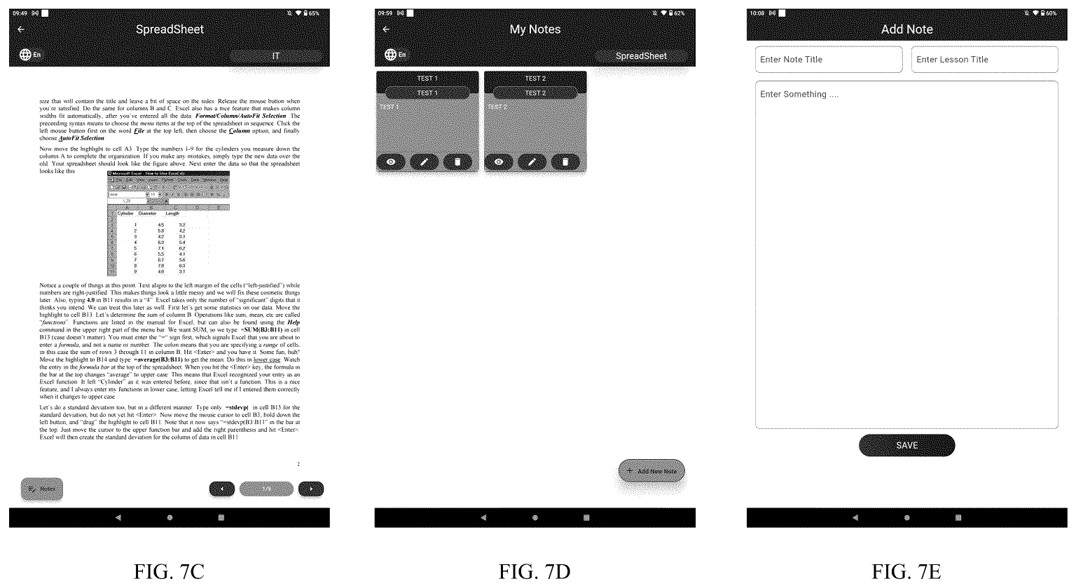

FIG. 7E illustrates an example interface of a student user interface configured to receive a personalization input, according to one or more example embodiments.

As shown in FIG. 7E, the example interface of the student user interface configured to receive the personalization input may include areas to provide the personalization information (i.e., personal note, entry fields corresponding to title, lesson title, description, etc.) Further, said example interface of the student user interface may also show additional information as well as include additional functionality associated with the classroom data management, such as an option to save/discard changes, an option to return to the previous page, and the like. The method then proceeds to operation S320.

At operation S320, the at least one processor may be configured to store the personalization data. The personalization data may be stored in the local database at the CDM system/target device.

For example, the CDM system may store in its local database a record specifying specific contents of the personal note, specific color of the highlight to a particular portion of the study material, and specific bookmark to a particular portion of the study material. The method then proceeds to operation S330.

At operation S330, the at least one processor may be configured to display personalized data along with the configured data associated with the school class assigned to the second user.

For example, the CDM system may display the IT book including highlights at various portions of the IT book.

According to example embodiments, the personalized data and the configured data associated with the school class assigned to the second user may be displayed to the second user on the target device. For example, the personalized data and the configured data associated with the school class assigned to the second user may be displayed via a display screen of a smart phone (target device) to the second user. According to example embodiments, the personalized data and the configured data associated with the school class assigned to the second user may be displayed to the second user via the student user interface.

Upon performing operation S330, the method 300 may be ended or be terminated. Alternatively, method 300 may return to operation S310, such that the at least one processor may be configured to repeatedly perform, for at least a predetermined amount of time, the receiving the personalization input (at operation S310), the storing the personalization data (at operation S320), and the displaying the personalization data and the configured data (at operation S330).

For example, the second user may initially provide the personalization input to the CDM system, and operations S310 to S330 may accordingly be performed as described above. Then at a later time, the second user may wish to read the IT book again with the added highlight. Accordingly, the method may return to operation S330 to display the personalization data and the configured data to the second user.

FIG. 4 illustrates a flow diagram of an example method 400 for receiving a configuration input from a first user, according to one or more example embodiments. One or more operations of method 400 may be part of operation S210 in method 200, and may be performed by at least one processor (e.g., processor 812) of the CDM system.

As illustrated in FIG. 4, at operation S410, the at least one processor may be configured to receive an identification information associated with the first user. The identification information may be received from the first user on the target device.

According to example embodiments, the identification information may include information specifying an identity of a particular school administrator in the educational institution. For example, the identification information may include a username and password combination, preset/predefined by said particular school administrator.

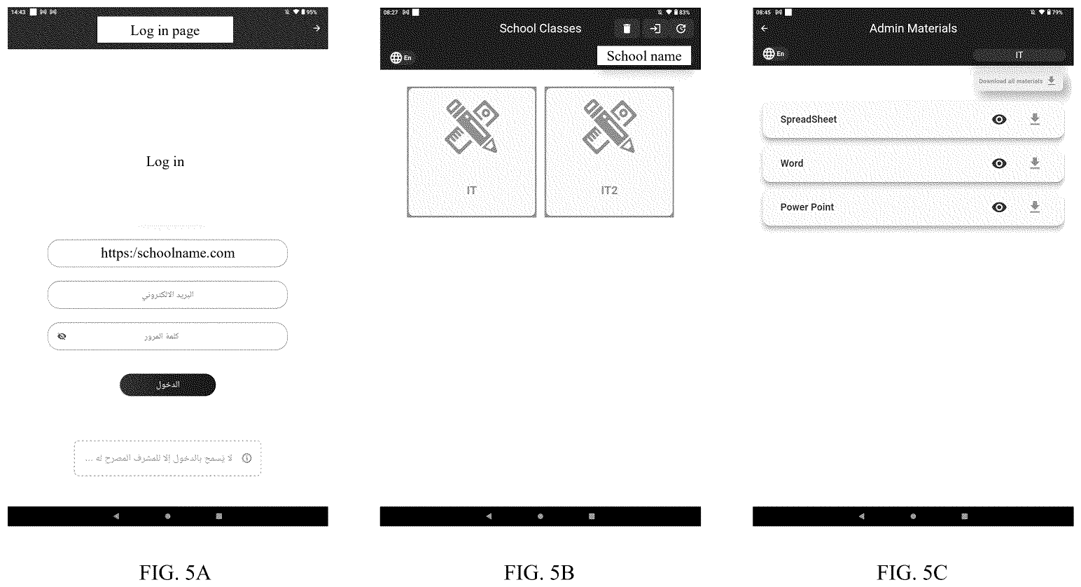

FIG. 5A illustrates an example interface of an administration user interface configured to receive an identification information, according to one or more example embodiments.

As shown in FIG. 5A, the example interface of the administration user interface configured to receive the identification information may include areas to provide the identification information (i.e., username and password). Further, said example interface of the administration user interface may also show additional information associated with the classroom data management, such as an address (e.g., URL) of the server and the like. The method then proceeds to operation S420.

At operation S420, the at least one processor may be configured to display one or more school classes which the first user is responsible for. The one or more school classes which the first user is responsible for may be displayed to the first user on the target device, and may be displayed based on the identification information associated with the first user.

In particular, as described above in relation to FIG. 1, the server may store identification information associated with a plurality of school administrator in the educational institution, as well as specify which of the plurality of school administrator is responsible for which of the plurality of school classes.

In this regard, according to example embodiments, the at least one processor may communicate with the server in order to identify the identity of the second user based on the received identification information, and then identify that the second user is responsible for which of the plurality of school classes.

For example, the server may store a preset username and password combination of Mr. Smith, along with specifying that Mr. Smith is responsible for geometry class, algebra class, IT class, and calculus class. Accordingly, during operation S410, Mr. Smith may provide his username and password combination to the CDM system. Then, during operation S420, the CDM system may transmit the username and password combination received during operation S410 to the server, where the server may verify and identify that the username and password combination received during operation S410 belongs to Mr. Smith. Subsequently, the server may identify that Mr. Smith is responsible for geometry class, algebra class, IT class, and calculus class, and provide data indicating the same to the CDM system. Accordingly, the CDM system may display the geometry class, algebra class, IT class, and calculus class (i.e., one or more school classes which the first user is responsible for) to the first user.

It is understood that, if the server is unable to verify and identify the identity of the first user based on the identification information (e.g., the provided username and password is incorrect), the server may transmit a notification to the CDM system indicating the same. Accordingly, the CDM system may display a notification to the first user indicating that the provided identification information is incorrect, and the method returns to operation S410, until a correct identification information is provided.

According to example embodiments, the at least one processor may be configured to display the one or more school classes which the first user is responsible for along with the name associated with the one or more school classes which the first user is responsible for.

FIG. 5B illustrates an example interface of an administration user interface configured to display one or more school classes which a first user is responsible for, according to one or more example embodiments.

As shown in FIG. 5B, the example interface of the administration user interface configured to display the one or more school classes which the first user is responsible for may show the one or more school classes which the first user is responsible for along with the associated names (i.e., IT and IT2). Further, said example interface of the administration user interface may also show additional information as well as include additional functionality associated with the classroom data management, such as a name of the school, an option to change the language, an option to delete (unassign) one or more school classes, an option to download an update, an option to exit a page, and the like. The method then proceeds to operation S430.

At operation S430, the at least one processor may be configured to receive a first selection input. The first selection input may be received from the first user on the target device, and may include an input to select at least one of the one or more school classes (i.e., displayed during operation S420).

For example, returning to the example in FIG. 5B, the first user may select IT2 class displayed on the administration user interface (e.g., by tapping on the touch screen). The method then proceeds to operation S440.

At operation S440, the at least one processor may be configured to display one or more study materials associated with the selected at least one of the one or more school classes. The one or more study materials associated with the selected at least one of the one or more school classes may be displayed to the first user on the target device.

In particular, as described above in relation to FIG. 1, the server may store one or more study materials that are associated with each of the plurality of school classes that are taught in the educational institution. The study materials here may include, for example, books, articles, presentation slides, home works, tests, and any similar materials that may be used by a school administrator to facilitate teaching and giving lessons to students.

In this regard, according to example embodiments, the at least one processor may communicate with the server in order to identify which study materials are associated with the selected at least one of the one or more school classes.

For example, the server may store an IT book that is associated with the IT class. Accordingly, during operation S440, the CDM system may transmit a request to receive one or more study materials associated with the selected at least one of the one or more school classes (e.g., one or more study materials associated with IT2 class). Subsequently, the server may identify that the IT2 class is associated with the IT book, and provide data indicating the same to the CDM system. Accordingly, the CDM system may display the IT book (i.e., one or more study materials associated with the selected at least one of the one or more school classes) to the first user.

FIG. 5C illustrates an example interface of an administration user interface configured to display one or more study materials associated with a selected at least one of one or more school classes, according to one or more example embodiments.

As shown in FIG. 5C, the example interface of the administration user interface configured to display the one or more study materials associated with the selected at least one of the one or more school classes may show the one or more study materials associated with the selected at least one of the one or more school classes (i.e., spreadsheet, word document of a book, and a power point slide). Further, said example interface of the administration user interface may also show additional information as well as include additional functionality associated with the classroom data management, such an option to download all study materials, an option to download each study materials separately, an option to preview the content of a particular study material, an option to return to the previous page, and the like. The method then proceeds to operation S450.

At operation S450, the at least one processor may be configured to receive a second selection input. The second selection input may be received from the first user on the target device, and may include an input to select at least one of the one of the one or more study materials (i.e., displayed during operation S440).

For example, returning to the example in FIG. 5C, the first user may select the spreadsheet displayed on the administration user interface (e.g., by tapping on the spreadsheet box or the download button on the spreadsheet box). The method then proceeds to operation S460.

At operation S460, the at least one processor may be configured to obtain the selected at least one of the one of the one or more study materials from the server.

For example, in response to receiving the selection input to select the spreadsheet, the CDM system may transmit a request to obtain/download the spreadsheet from the server, where the server may accordingly provide the same to the CDM system.

In this regard, according to example embodiments, the at least one processor may store the obtained study material in the local database of the CDM system. Further, according to example embodiments, the at least one processor may store a record of the selected at least one of the one or more school classes in the local database, as the record of a school class that is assigned to the second user.

According to example embodiments, after obtaining the selected at least one of the one of the one or more study materials from the server, the first user may log off from the CDM system. Subsequently, according to example embodiments, the CDM system may return to display the student user interface, such as the example shown in FIG. 7A.

FIG. 6 illustrates a flow diagram of an example method 600 for displaying configured data associated with a school class assigned to a second user, according to one or more example embodiments. One or more operations of method 600 may be part of operation S230 in method 200, and may be performed by at least one processor (e.g., processor 812) of the CDM system.

As illustrated in FIG. 6, at operation S610, the at least one processor may be configured to display one or more school classes assigned to the second user, and the name associated with each of the one or more school classes assigned to the second user.

The one or more school classes assigned to the second user may be displayed to the second user on the target device.

The one or more school classes assigned to the second user, and the name associated with each of the one or more school classes assigned to the second user may be displayed based on the configured data associated with the school class assigned to the second user described above in relation to operation S210 in method 200 as well as in method 400.

FIG. 7A illustrates an example interface of a student user interface configured to display one or more school classes assigned to a second user, according to one or more example embodiments.

As shown in FIG. 7A, the example interface of the student user interface configured to display the one or more school classes assigned to the second user may show the one or more school classes assigned to the second user along with the associated names (i.e., IT and IT2). Further, said example interface of the student user interface may also show additional information as well as include additional functionality associated with the classroom data management, such as an option to log in as a school administration (where the CDM system may change to display the administration user interface as shown in FIG. 5A), an option to turn on wireless communication (i.e., Wi-Fi), a battery level of the target device, an option to change the language, a name of the school, and the like. The method then proceeds to operation S620.

At operation S620, the at least one processor may be configured to receive a third selection input. The third selection input may be received from the second user on the target device, and may include an input to select at least one of the one or more school classes assigned to the second user (i.e., displayed during operation S610).

For example, returning to the example in FIG. 7A, the second user may select IT2 class displayed on the student user interface (e.g., by tapping on the touch screen). The method then proceeds to operation S630.

At operation S630, the at least one processor may be configured to display one or more study materials associated with the selected at least one of the one or more school classes assigned to the second user. The one or more study materials associated with the selected at least one of the one or more school classes assigned to the second user may be displayed to the second user on the target device.

In particular, as described above in relation to method 400, the first user may select and obtain (download) various study materials associated with various school classes, which may be stored in the local database of the CDM system.

As such, according to example embodiments, the at least one processor may be configured to display one or more study materials associated with the selected at least one of the one or more school classes assigned to the second user that are stored in the local database.

For example, the CDM system may store the IT book that is associated with the IT2 class in the local database. Accordingly, in response to the second user selecting the IT2 class during operation S620, during operation S630, the CDM system may display the IT book that is associated with the IT2 class (one or more study materials associated with the selected at least one of the one or more school classes assigned to the second user that are stored in the local database) to the second user.

FIG. 7B illustrates an example interface of a student user interface configured to display one or more study materials associated with a selected at least one of one or more school classes assigned to the second user, according to one or more example embodiments.

As shown in FIG. 7B, the example interface of the student user interface configured to display the one or more study materials associated with the selected at least one of the one or more school classes assigned to the second user may show the one or more study materials associated with the selected at least one of the one or more school classes assigned to the second user (i.e., spreadsheet). Further, said example interface of the student user interface may also show additional information as well as include additional functionality associated with the classroom data management, such as an option to change the language, an option to resize the font, and the like. The method then proceeds to operation S640.

At operation S640, the at least one processor may be configured to receive a fourth selection input. The fourth selection input may be received from the second user on the target device, and may include an input to select at least one of the one of the one or more study materials (i.e., displayed during operation S630).

For example, returning to the example in FIG. 7B, the second user may select the spreadsheet displayed on the student user interface (e.g., by tapping on the spreadsheet box). The method then proceeds to operation S650.

At operation S650, the at least one processor may be configured to display a content of the selected at least one of the one of the one or more study materials. The content of the selected at least one of the one of the one or more study materials may be displayed to the second user on the target device.

For example, in response to the second user selecting the IT book during operation S640, during operation S650, the CDM system may display the content of the IT book (content of the selected at least one of the one of the one or more study materials) to the second user.

FIG. 7C illustrates an example interface of a student user interface configured to display a content of a selected at least one of one of the one or more study materials, according to one or more example embodiments.

As shown in FIG. 7C, the example interface of the student user interface configured to display the content of the selected at least one of the one of the one or more study materials may show the content of the selected at least one of the one of the one or more study materials (i.e., content of the spreadsheet).

Further, said example interface of the student user interface may also show additional information as well as include additional functionality associated with the classroom data management, such as a name of the school class, an option to change the language, a page number, an option to move between pages, an option to scroll through the page, an option to return to the previous page, and the like.

According to example embodiments, the content may be displayed along with one or more of: a personal note associated with the study material, a highlight of a portion of the study material; and a bookmark of a portion of the study material.

For example, returning to the example in FIG. 7C, the content of the spreadsheet may be displayed along with highlights (bold and underline) at various portions of the content of the spreadsheet.

In another example, the content of the spreadsheet may be displayed along with a personal note associated with the study material at the bottom left corner. In the example shown in FIG. 7C, the student user interface may include a personal note button to open the personal note, where the at least one processor may be configured to display the content of the personal note in response to the second user selecting the personal note button.

FIG. 7D illustrates an example interface of a student user interface configured to display a content of a personal note associated with a study material, according to one or more example embodiments.

As shown in FIG. 7D, the example interface of the student user interface configured to display the content of the personal note associated with the study material may show the content of the content of the personal note associated with the study material (i.e., personal notes “TEST1” and “TEST2” associated with the spreadsheet). Here, the personal note may be reviewed by the first user to evaluate the second user's learning.

Further, said example interface of the student user interface may also show additional information as well as include additional functionality associated with the classroom data management, such as a name of the study material, an option to change the language, an option to modify the personal note (add, edit, delete, etc.), and the like.

Accordingly, the above processes enable efficient and effective management of data associated with the classroom in light of the increase in complexity, as well as to facilitate the learning process through such managed data.

In particular, the above processes provide easy and efficient assignment of school classes to a particular school student as well as provision of specific study materials, which can also be easily and efficiently viewed and studied by the particular school student.

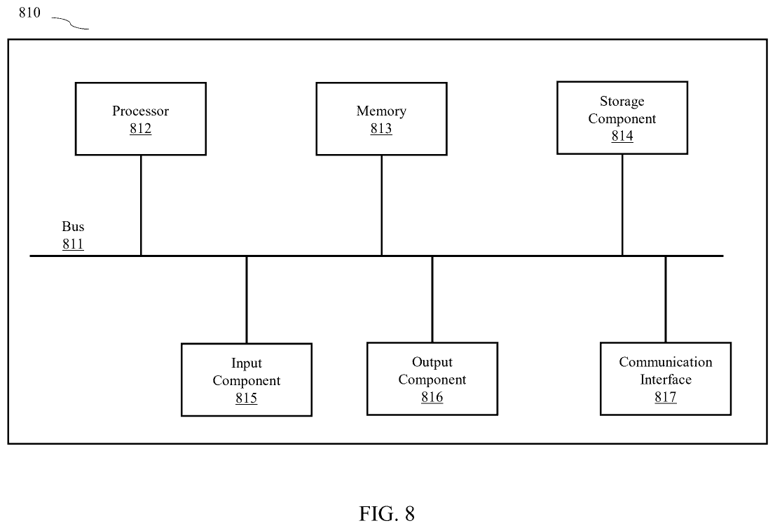

FIG. 8 illustrates a block diagram of example components in a system 810, according to one or more example embodiments. The system 810 may correspond to the CDM system 120 in FIG. 1, thus the features associated with the CDM system 120 and the system 810 may be similarly applicable to each other, unless being explicitly described otherwise.

As illustrated in FIG. 8, the system 810 may include at least one bus 811, at least one processor 812, at least one memory 813, at least one storage component 814, at least one input component 815, at least one output component 816, and at least one communication interface 817.

It is contemplated that the system 810 may include more or less components than illustrated in FIG. 8, without departing from the scope of the present disclosure. For instance, in some embodiments, the system 810 may include a plurality of storage components 814, the input component 815 and the output component 816 may be implemented as a transceiver component, the memory 813 and storage component 814 may be implemented as a memory storage, and the like.

The bus 811 may be configured to facilitate or enable communications among the components of the system 810. Specifically, the bus 811 may communicatively couple the components to each other and provide a means for data transfer and flow of control signals between the components. The bus 811 may include one or more of: an internal bus, an address bus, a data bus, a control bus, a controller area network (CAN) bus, an Ethernet bus, a peripheral component interconnect express (PCIe) bus, and any other suitable type of bus that can be implemented in the system 810 to enable communication and coordination between the components within the system 810 in real-time (or near real-time).

The processor 812 may be implemented in hardware, firmware, or a combination of hardware and software, and may be configured to handle real-time (or near real-time) data processing and control of the control system 810. The processor 812 may include one or more of: a central processing unit (CPU), a graphics processing unit (GPU), a neural processing unit (NPU), a tensor processing unit (TPU), an accelerated processing unit (APU), a microprocessor, a microcontroller, a digital signal processor (DSP), a field-programmable gate array (FPGA), an application-specific integrated circuit (ASIC), and/or another type of processing or computing component that can be implemented in the system 810. In some implementations, the processor 812 may be capable of being programmed to perform one or more operations described herein. Further, the processor 812 may include a plurality of processing units, each of which is dedicated to performing a specific operation.

The memory 813 may include one or more mediums for storing temporary data, runtime variables, program instructions, and buffers required for the operations of the control system 810. The memory 813 may include one or more of: a flash memory, a read-only memory (ROM), a random-access memory (RAM), a dynamic or static storage device (e.g., a flash memory, a magnetic memory, and/or an optical memory), any other suitable type of memory that can be implemented in the system 810 to store information and/or instructions for use by the processor 812.

The storage component 814 may be configured to store non-volatile data, such as firmware, configuration settings, calibration data, information, and/or software related to the operation and use of the system 810. For example, the storage component 814 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

According to example embodiments, the storage component 814 may be configured to store computer-readable or computer-executable instructions for implementing one or more operations of the system 810. The storage component 814 may provide the stored information to the memory 813 for the execution of the processor 812.

The input component 815 may include one or more input components that permit the system 810 to receive information, such as via user input (e.g., a touch screen display, a keyboard, a keypad, a mouse, a button, a switch, and/or a microphone). The output component 816 may include one or more output components that provide output information from the system 810 (e.g., a display, a speaker, a navigation device, one or more light-emitting diodes (LEDs), etc.) According to example embodiments, the input component 815 and/or the output component 816 may be optional and may be excluded from the system 810.

The at least one communication interface 817 may include a transceiver-like component (e.g., a transceiver and/or a separate receiver and transmitter) that enables the system 810 to communicate with other components (e.g., ECUs, user devices, etc.), such as via a wired connection, a wireless connection, or a combination of wired and wireless connections. For example, communication interface 817 may include a controller area network (CAN) bus interface, an Ethernet interface, an optical interface, a coaxial interface, an infrared interface, a radio frequency (RF) interface, a universal serial bus (USB) interface, a Wi-Fi interface, a cellular network interface, or the like.

According to one or more embodiments, the communication interface 817 may include at least one input/output (I/O) interface, at least one network interface, at least one storage interface, or the like, that enable the components 812-816 to communicate with other components. Further, the communication interface 817 may include one or more application programming interfaces (APIs) that allow the system 810 (or one or more components included therein) to communicate with one or more software applications (e.g., software application deployed in the ECUs, etc.) Computer-executable instructions (e.g., software instructions, etc.) may be read into memory 813 and/or storage component 814 from another computer-readable medium or from another device (e.g., a remote server, an external storage, etc.) via, for example, the communication interface 817. When executed, the computer-executable instructions stored in memory 813 and/or storage component 814 may cause the processor 812 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of example embodiments of the present disclosure, as well as the associated technical advantages and significances, are provided in the following.

It is understood that the specific order or hierarchy of blocks in the /ocesses/ flowcharts disclosed herein is an illustration of example approaches. Based upon design preferences, it is understood that the specific order or hierarchy of blocks in the /ocesses/ flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer-readable medium at any possible technical detail level of integration. Further, as described hereinabove, one or more of the above components described above may be implemented as instructions stored on a computer readable medium and executable by at least one processor (and/or may include at least one processor) . The computer-readable medium may include a computer-readable non-transitory storage medium (or media) having computer-readable program instructions thereon for causing a processor (or processors) to carry out operations.

The computer readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming languages such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a SoC, a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or another device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A system comprising:
a memory storage storing computer-executable instructions; and
at least one processor communicatively coupled to the memory storage, wherein the at least one processor is configured to execute the instructions to:
receive, from a first user on a target device, a configuration input to configure data associated with a school class assigned to a second user;
store, on the target device, the configured data; and
display, to the second user on the target device, the configured data associated with the school class assigned to the second user;
wherein the configured data associated with the school class assigned to the second user comprises: one or more school classes assigned to the second user, a name associated with each of the one or more school classes assigned to the second user, and a study material associated with each of the one or more of school classes.

2. The apparatus according to claim 1, wherein the at least one processor is configured to receive the configuration input from the first user by:
receiving, from the first user on the target device, an identification information associated with the first user;
displaying, to the first user on the target device, one or more school classes which the first user is responsible for based on the identification information associated with the first user;
receiving, from the first user on the target device, a first selection input to select at least one of the one or more school classes;
displaying, to the first user on the target device, one or more study materials associated with the selected at least one of the one or more school classes;
receiving, from the first user on the target device, a second selection input to select at least one of the one of the one or more study materials; and
obtaining, from a server, the selected at least one of the one of the one or more study materials.

3. The apparatus according to claim 1, wherein the at least one processor is further configured to receive, from the second user on the target device, a personalization input to personalize the configured data associated with the school class assigned to the second user.

4. The apparatus according to claim 3, wherein the personalization input comprises at least one of: an input to configure a personal note associated with a study material associated with one or more school classes assigned to the second user, an input to highlight a portion of the study material, and an input to bookmark a portion of the study material.

5. The apparatus according to claim 1, wherein the at least one processor is configured to display the configured information associated with the school class assigned to the second user by:
displaying, to the second user on the target device, the one or more school classes assigned to the second user, and the name associated with each of the one or more school classes assigned to the second user;
receiving, from the second user on the target device, a third selection input to select at least one of the one or more school classes assigned to the second user;
displaying, to the second user on the target device, one or more study materials associated with the selected at least one of the one or more school classes assigned to the second user;
receiving, from the second user on the target device, a fourth selection input to select at least one of the one of the one or more study materials; and
displaying, to the second user on the target device, a content of the selected at least one of the one of the one or more study materials.

6. The apparatus according to claim 5, wherein the content is displayed along with one or more of: a personal note associated with the study material, a highlight of a portion of the study material; and a bookmark of a portion of the study material.

7. The apparatus according to claim 1, wherein the system comprises an administration user interface and a student user interface, wherein the configuration input is received from the first user via the administration user interface, and wherein the configured data associated with the school class assigned to the second user is displayed to the second user via the student user interface.

8. A method comprising:
receiving, from a first user on a target device, a configuration input to configure data associated with a school class assigned to a second user;
storing, on the target device, the configured data; and
displaying, to the second user on the target device, the configured data associated with the school class assigned to the second user;
wherein the configured data associated with the school class assigned to the second user comprises: one or more school classes assigned to the second user, a name associated with each of the one or more school classes assigned to the second user, and a study material associated with each of the one or more of school classes.

9. The method according to claim 8, wherein the receiving the configuration input from the first user comprises:
receiving, from the first user on the target device, an identification information associated with the first user;
displaying, to the first user on the target device, one or more school classes which the first user is responsible for based on the identification information associated with the first user;
receiving, from the first user on the target device, a first selection input to select at least one of the one or more school classes;
displaying, to the first user on the target device, one or more study materials associated with the selected at least one of the one or more school classes;
receiving, from the first user on the target device, a second selection input to select at least one of the one of the one or more study materials; and
obtaining, from a server, the selected at least one of the one of the one or more study materials.

10. The method according to claim 8, wherein the method further comprises receiving, from the second user on the target device, a personalization input to personalize the configured data associated with the school class assigned to the second user.

11. The method according to claim 10, wherein the personalization input comprises at least one of: an input to configure a personal note associated with a study material associated with one or more school classes assigned to the second user, an input to highlight a portion of the study material, and an input to bookmark a portion of the study material.

12. The method according to claim 8, wherein the displaying the configured information associated with the school class assigned to the second user comprises:
displaying, to the second user on the target device, the one or more school classes assigned to the second user, and the name associated with each of the one or more school classes assigned to the second user;
receiving, from the second user on the target device, a third selection input to select at least one of the one or more school classes assigned to the second user;
displaying, to the second user on the target device, one or more study materials associated with the selected at least one of the one or more school classes assigned to the second user;
receiving, from the second user on the target device, a fourth selection input to select at least one of the one of the one or more study materials; and
displaying, to the second user on the target device, a content of the selected at least one of the one of the one or more study materials.

13. The method according to claim 12, wherein the content is displayed along with one or more of: a personal note associated with the study material, a highlight of a portion of the study material;
and a bookmark of a portion of the study material.

14. The method according to claim 8, wherein the method is performed by a system comprising an administration user interface and a student user interface, wherein the configuration input is received from the first user via the administration user interface, and wherein the configured data associated with the school class assigned to the second user is displayed to the second user via the student user interface.

15. A non-transitory computer-readable recording medium having recorded thereon instructions executable by at least one processor to cause the at least one processor to perform a method comprising:
receiving, from a first user on a target device, a configuration input to configure data associated with a school class assigned to a second user;
storing, on the target device, the configured data; and
displaying, to the second user on the target device, the configured data associated with the school class assigned to the second user;
wherein the configured data associated with the school class assigned to the second user comprises: one or more school classes assigned to the second user, a name associated with each of the one or more school classes assigned to the second user, and a study material associated with each of the one or more of school classes.

16. The non-transitory computer-readable recording medium according to claim 15, wherein the receiving the configuration input from the first user comprises:
receiving, from the first user on the target device, an identification information associated with the first user;
displaying, to the first user on the target device, one or more school classes which the first user is responsible for based on the identification information associated with the first user;
receiving, from the first user on the target device, a first selection input to select at least one of the one or more school classes;
displaying, to the first user on the target device, one or more study materials associated with the selected at least one of the one or more school classes;
receiving, from the first user on the target device, a second selection input to select at least one of the one of the one or more study materials; and
obtaining, from a server, the selected at least one of the one of the one or more study materials.

17. The non-transitory computer-readable recording medium according to claim 15, wherein the method further comprises receiving, from the second user on the target device, a personalization input to personalize the configured data associated with the school class assigned to the second user.

18. The non-transitory computer-readable recording medium according to claim 17, wherein the personalization input comprises at least one of: an input to configure a personal note associated with a study material associated with one or more school classes assigned to the second user, an input to highlight a portion of the study material, and an input to bookmark a portion of the study material.

19. The non-transitory computer-readable recording medium according to claim 15, wherein the displaying the configured information associated with the school class assigned to the second user comprises:
displaying, to the second user on the target device, the one or more school classes assigned to the second user, and the name associated with each of the one or more school classes assigned to the second user;
receiving, from the second user on the target device, a third selection input to select at least one of the one or more school classes assigned to the second user;
displaying, to the second user on the target device, one or more study materials associated with the selected at least one of the one or more school classes assigned to the second user;
receiving, from the second user on the target device, a fourth selection input to select at least one of the one of the one or more study materials; and
displaying, to the second user on the target device, a content of the selected at least one of the one of the one or more study materials.

20. The non-transitory computer-readable recording medium according to claim 19, wherein the content is displayed along with one or more of: a personal note associated with the study material, a highlight of a portion of the study material; and a bookmark of a portion of the study material.
